(19) United States
(12) Patent Application Publication
(10) Pub. No.: US 2025/0365800 A1
(43) Pub. Date: Nov. 27, 2025

(54) FACILITATING ADMISSION CONTROL IN ADVANCED COMMUNICATION NETWORKS

(71) Applicant: Dell Products L.P., Round Rock, TX (US)

(72) Inventors: Amr Abdalla, Sers Layyan (EG); Marwan Mansour, Alexandria (EG); Umair Sajid Hashmi, Mississauga (CA); Jeebak Mitra, Ottawa (CA); Mohamed Abouzeid, El sheikh Zayed (EG); Abdulrahman Darwish, Cairo (EG); Mina Khalaf Saad Girgis Mokussa, Abd El-Aziz (EG)

(21) Appl. No.: 18/672,212

(22) Filed: May 23, 2024

(51) Int. Cl. H04W 76/18; H04W 28/02; H04W 48/08

(52) U.S. Cl. CPC H04W 76/18; H04W 28/0236; H04W 48/08

(57) ABSTRACT

Facilitating admission control in advanced communication networks is provided. A method includes, based on receipt of a request from a user equipment for admission into a communication network, analyzing, by a system comprising at least one processor, information indicative of stochastic measurements of the communication network, resulting in an adaptive threshold. The method also includes, based on the adaptive threshold being determined to satisfy a defined admission control criterion, facilitating, by the system, admission of the user equipment into the communication network. Further, the method includes, based on the adaptive threshold being determined to fail to satisfy the defined admission control criterion, denying, by the system, the admission of the user equipment into the communication network.

### BACKGROUND

The use of computing devices is ubiquitous. Given the explosive demand placed upon mobility networks and the advent of advanced use cases (e.g., streaming, gaming, and so on), quality of service demands in such networks can be a concern. Such concerns can be attributed to the exponential increase in the network traffic flowing through the advanced network and the need for faster processing of complex tasks. Accordingly, unique challenges exist related to network efficiency and in view of forthcoming Fifth Generation (5G), new radio (NR), Sixth Generation (6G), or other next generation, standards for wireless network communication.

The above-described context with respect to wireless communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes, based on receipt of a request from a user equipment for admission into a communication network, analyzing, by a system comprising at least one processor, information indicative of stochastic measurements of the communication network, resulting in an adaptive threshold. The method also includes, based on the adaptive threshold being determined to satisfy a defined admission control criterion, facilitating, by the system, admission of the user equipment into the communication network. Further, the method includes, based on the adaptive threshold being determined to fail to satisfy the defined admission control criterion, denying, by the system, the admission of the user equipment into the communication network.

The information indicative of stochastic measurements of the communication network comprises performance indicators measured over a defined time interval. For example, the performance indicators can include a delay measurement, a reference signal received power measurement, a signal to interference noise ratio measurement, and/or another performance indicator with respect to a user in the network. In some implementations, the defined admission control criterion is a function of a quality of service satisfaction target variable.

The analyzing can include, according to some implementations, using information indicative of aggregate rejections of historical admission requests from other user equipment, other than the user equipment trying to connect to the network, as a contributing factor for an admission decision relating to the admission of the user equipment. Further to these implementations, the method can include, based on the information indicative of aggregate rejections, facilitating a balancing between a total number of user equipment admitted into the communication network and a quality of service satisfaction level.

According to some implementations, the analyzing can include using a configurable priority between a number of connection rejections and a quality of service satisfaction level. In some implementations, prior to the analyzing, the method can include training, by the system, a model to a first defined confidence level. The model can be a deep learning machine learning model or another type of model.

In accordance with some implementations, the analyzing can include determining a difference metric between a measured quality of service level for the user equipment and a quality of service level predefined in a service level agreement for the user equipment. In some implementations, the communication network can be configured to operate according to a fifth generation network communication protocol or another type of communication protocol.

Another embodiment relates to a system that includes at least one processor and at least one memory that stores executable instructions that, when executed by the at least one processor, facilitate performance of operations. The operations can include, based on receipt of a request from a user equipment for admission to a cellular network, determining an admission threshold for the user equipment. The admission threshold can be based on stochastic measurements applicable to the cellular network. The operations can also include analyzing the admission threshold with respect to a defined admission control criterion. In an implementation, based on the admission threshold being determined to satisfy the defined admission control criterion, the operations can include granting the request for admission to the cellular network. In an alternative implementation, based on the admission threshold being determined not to satisfy the defined admission control criterion, the operations can include denying the request for admission to the cellular network. In an example, determining of the admission threshold can include using a configurable priority between a number of connection rejections and a quality of service satisfaction level.

The stochastic measurements applicable to the cellular network can include network performance indicators that are measured over a defined time interval. The defined admission control criterion can specify a quality of service satisfaction target. For example, the quality of service satisfaction target can be a variable on a scale from 0 to 1.

In some implementations, the receipt of the request is the receipt of a current admission request. Further to these implementations, determining of the admission threshold for the user equipment can include aggregating an amount of admission request denials applied over a defined period, prior to the current admission request. Further, determining of the admission threshold for the user equipment can include balancing the amount of admission request denials applied over the defined period and a quality of service satisfaction level.

Yet another embodiment relates to a non-transitory machine-readable medium, comprising executable instructions that, when executed by a processor of network equipment, facilitate performance of operations. The operations can include, based on an admission request from a user equipment for admission into a wireless communication network, analyzing information indicative of stochastic measurements made with respect to the wireless communication network, resulting in an adaptive threshold. The operations can also include, based on the adaptive threshold being determined to satisfy a defined admission control criterion, enabling admission of the user equipment into the wireless communication network. In an alternative implementation, based on the adaptive threshold being determined to fail to satisfy the defined admission control criterion, the operations can include preventing the admission of the user equipment into the wireless communication network.

In an example, the analyzing can include analyzing a result of using a configurable priority between a number of connection rejections and a quality of service satisfaction level. In another example, the information indicative of stochastic measurements of the wireless communication network can include performance indicators measured over a defined time interval. The performance indicators can include at least one of a delay measurement, a reference signal received power measurement, a signal to interference noise ratio measurement, and/or another performance indicator.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, system that facilitates admission control in accordance with one or more embodiments;

FIG. 2 illustrates an example, non-limiting, graph of results using deep learning based admission control without implementation of the one or more embodiments provided herein;

FIG. 3 illustrates a flow diagram of an example, non-limiting, computer-implemented method that facilitates admission control in advanced communication networks in accordance with one or more embodiments described herein;

FIG. 4 illustrates an example, non-limiting, system in accordance with one or more embodiments described herein;

FIG. 5 illustrates an example, non-limiting, quality of service satisfaction model in accordance with one or more embodiments described herein;

FIG. 6 illustrates an example, non-limiting, graph of a comparison between a probability of admission at a certain time as compared to a score for each cell according to one or more embodiments described herein;

FIG. 7 illustrates an example, non-limiting, flow diagram of the inputs to and the outputs from the admission control module according to one or more embodiments described herein;

FIG. 8 illustrates a block diagram of an example, non-limiting, system that facilitates training a model for selective and dynamic user equipment admission control in accordance with one or more embodiments described herein;

FIG. 9 illustrates a flow diagram of an example, non-limiting, computer-implemented method that facilitates selective and dynamic admission control in advanced communication networks in accordance with one or more embodiments described herein;

FIG. 10 illustrates an example, non-limiting, computing environment in which one or more embodiments described herein can be facilitated; and

FIG. 11 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

As wireless networks become denser and cater to diverse user equipment (UE) types and demands, optimal resource allocation of resources within the network becomes a challenge. In a network environment, there is need to switch the traffic across cells based on changes in radio environment, user mobility, and/or application requirements to satisfy performance requirements. This may also necessitate a traffic split across multiple tiers (e.g., macro, small cells).

For cellular communication, admission control refers to the decision process related to accepting a certain user equipment (UE) into the network for communication. The decision is typically taken using a predefined criteria such as load (e.g., number of users or Physical Resource Block (PRB) utilization level).

Conventional approaches assume a fixed relation between load and a Service Level Agreement (SLA) on the one hand, and admission control thresholds on the other hand. This, however, does not work well in the case of aperiodic traffic with heterogenous Quality of Service (QoS) satisfaction levels.

The disclosed embodiments provide deep learning (DL)-based admission control policy. The DL-based admission control module can be configured to capture the semi-observable time-varying bandwidth, reconfigurable priority between maintaining SLA satisfaction and avoiding denial of service, and the channel conditions due to network planning.

As it relates to admission control, the objective is to maximize the total number of user equipment (UEs) admitted in the network while ensuring that the network is able to meet or exceed the QoS requirements of the UEs that are already connected to the network. A challenge associated with this is that the QoS satisfaction level of UEs is difficult to model. Generally, this is needed by the admission control algorithm and is not accurately modeled by considering only the total number of UEs only, since the (time-varying) channel conditions and availability of resources on different cells may change the optimal number of admitted UEs.

Further, in disaggregated networks, Network Functions (NFs), such as, for example distributed unit (DU) and centralized unit (CU), of the same gNBs or neighboring gNBs could potentially be designed by different vendors. Accordingly, such NFs could adopt different network control process, of which admission control is an important network control process. In such a heterogenous environment, it is challenging to find the optimal configuration and admission control criteria that works for the different deployment realizations and QoS flow prioritization.

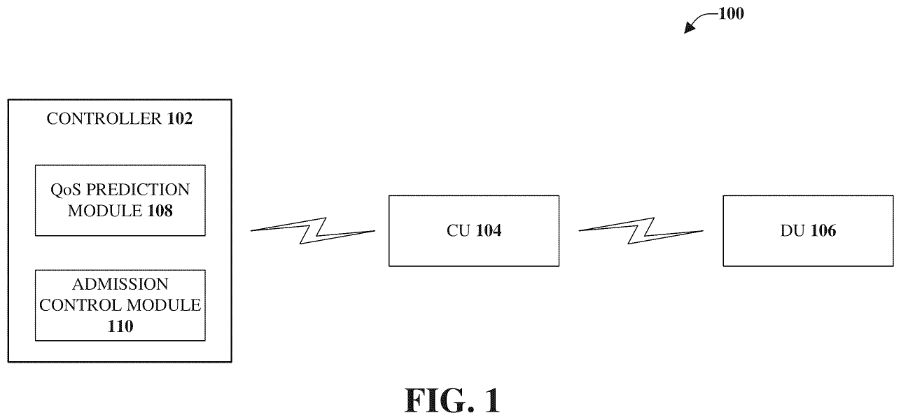

FIG. 1 illustrates an example, non-limiting, system 100 that facilitates admission control in accordance with one or more embodiments. The system 100 includes one or more network equipment illustrated as a controller 102, a CU 104, and a DU 106. The controller 102 can include a QoS prediction module 108 and an admission control module 110.

The disclosed embodiments address admission control by employing a stochastic approach to decision making. Additionally, the disclosed embodiments introduce Radio Resource Control (RRC) Request Rejections as a factor in the decision function. In doing so, the network operator can specify a weighted priority for the algorithm between protecting the QoS for existing UEs and avoiding denial of service for new UEs. Further, the disclosed embodiments use the predicted QoS satisfaction for the UEs and the current rejection ratio of the cell, together with the assigned priority to each term, to determine whether the cell should admit more UEs or not.

Some conventional approaches have assumed joint centralized slicing and admission control decisions. Centralized admission control decides on user association for all UEs simultaneously. Such assumptions may not be realistic since all UEs do not arrive simultaneously. Additionally, cellular traffic is time-varying and aperiodic that changes both the traffic load and the spectrum allocation compared to the values used during admission control decisions.

Some approaches provided a method for admission control decision making based on the predicted effect on the existing UEs QoS. Those approaches maximize the number of admissions while keeping the existing UEs QoS within a preset threshold. The disadvantages associated with the above approaches is that such approaches focus solely on the QoS eventually leading to repeated denial of service to new users (when the cell saturates). In some cases, denial of service is not an acceptable outcome.

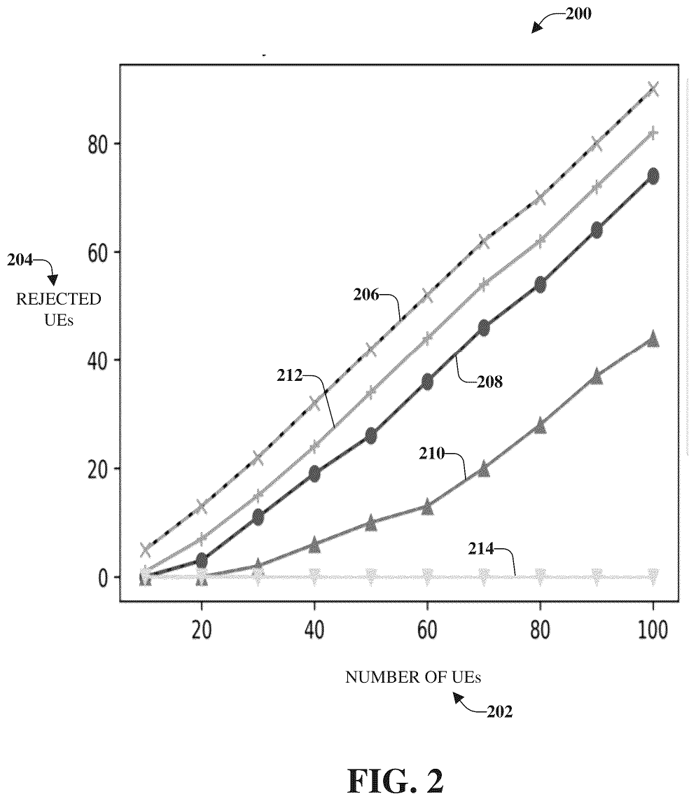

For example, FIG. 2 illustrates an example, non-limiting, graph 200 of results using deep learning based admission control without implementation of the one or more embodiments provided herein. The horizontal axis 202 of the graph 200 represents the number of UEs and the vertical axis 204 of the graph represents the number of rejected UEs.

A first line 206 within the graph 200 indicates a fixed threshold 2 simulation (packet interarrival times 1 millisecond (ms) and 10 ms). A second line 208 indicates a fixed threshold 4 simulation (packet interarrival times 1 ms and 10 ms). Further, a third line 210 indicates a fixed threshold 8 simulation packet interarrival times 1 ms and 10 ms). A fourth line 212 indicates a Machine Learning (ML)-based simulation (packet interarrival times 1 ms and 10 ms). In addition, a fifth line 214 indicates no access control simulation (packet interarrival times 1 ms and 10 ms).

As indicated in the graph 200, with a higher number of UEs (horizontal axis 202), the solution proportionally increases rejection of the connection request (vertical axis 204). These results from conventional use of deep learning based admission control are not desirable and result in a negative user experience.

With continuing reference to FIG. 1, the QoS prediction module 108 is configured to perform QoS prediction and the admission control module 110 is configured to facilitate admission control for one or more UEs. Although not illustrated in FIG. 1, the controller 102, the CU 104, and/or the DU 106 can respectively include one or more memories, one or more processors, and one or more data stores.

For the QoS prediction, the QoS prediction module 108 can utilize a deep learning ML model based on network measurements received from the CU 104. The QoS prediction module 108 can periodically, or based on another time interval, predict a ratio of satisfaction of the UEs on a given cell with respect to a fixed SLA. Information indicative of the ratio of satisfaction is communicated to the admission control module 110 for decision making. The output of the admission control module 110 is a prediction of the satisfaction ratio (between 0-1). In some implementations, a higher value denotes a greater QoS. However, in some implementations, a lower value is utilized to denote the greater QoS. In an example, the SLA and/or QoS can be based on a user equipment class defined for the UE.

For the admission control, the admission control module 110 can be triggered periodically, or based on another time interval, upon or after the QoS predictions are updated. Together with a ratio of connection request rejections, the admission control module 110 calculates a “score” for each cell. The score is used to generate a probability for each cell, which determines whether to admit or reject incoming UEs to a given cell. The admission decision can be communicated to the CU 104. Further, the DU 106 can facilitate scheduling of the UEs based on the admission control decisions.

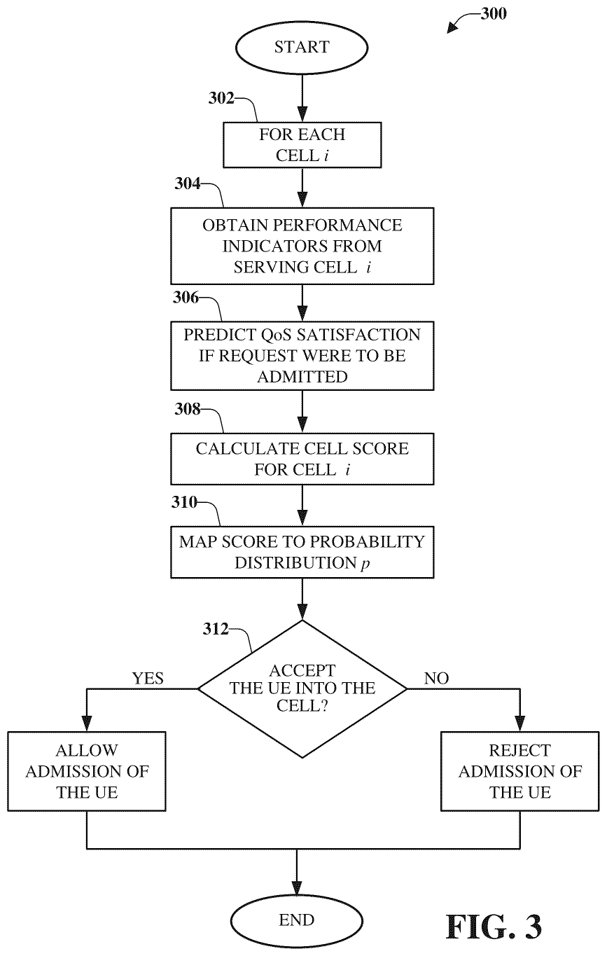

FIG. 3 illustrates a flow diagram of an example, non-limiting, computer-implemented method 300 that facilitates admission control in advanced communication networks in accordance with one or more embodiments described herein. Repetitive description of like elements employed in other embodiments described herein is omitted for sake of brevity. The computer-implemented method 300 and/or other methods discussed herein can be implemented by a system comprising at least one processor and at least one memory. In an example, the system can be implemented by a network equipment of a disaggregated network architecture. For example, the computer-implemented method 300 can be implemented by the system 100 of FIG. 1.

The use-case example of FIG. 3 provides an opportunistic solution for admission control that assumes no explicit knowledge about the slicing algorithm. The admission control module (e.g., the admission control module 110 of FIG. 1) can be triggered periodically (or at another time interval and/or based on a triggering event), and it loops over each cell i, as indicated at 302.

At 304, the computer-implemented method 300, requests or otherwise obtains current network measurements of the cell i. The current network measurements can be obtained from the CU (e.g., the CU 104 of FIG. 1). The current network measurements can include one or more performance indicators, which can be key performance indicators (KPIs). For example, the network measurements can include, but are not limited to, delay measurements, Reference Signal Received Power (RSRP), Signal to Interference Noise Ratio (SINR), and so on.

Based on the current network measurements, at 306, the computer-implemented method 300 predicts the average QoS satisfaction metric on cell i if the UE requesting admission were to be admitted to the cell. At 308, the cell score for cell i is determined. Further, at 310, the predicted QoS satisfaction and the number of RRC connection rejections are used to calculate a probability, shown as p, of admitting a UE to cell i.

At 312 a determination is made whether or not to admit the UE to the cell. To make the determination, the computer-implemented method 300 determines the possibility of admitting the UE from the calculated probability p, for cell i, and the UE is admitted based on this probability. If it is determined to admit incoming UEs (“YES”), the UE is admitted at 314. Otherwise, the decision is to reject incoming RRC requests (“NO”), and the computer-implemented method 300 ends.

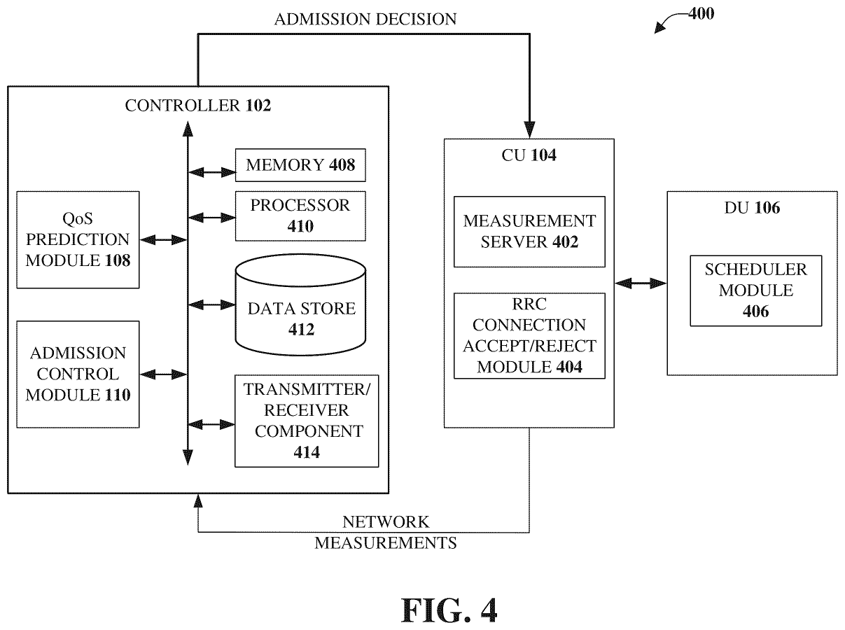

FIG. 4 illustrates an example, non-limiting, system 400 in accordance with one or more embodiments described herein. Repetitive description of like elements employed in other embodiments described herein is omitted for sake of brevity. The system 400 can comprise one or more of the components, modules, and/or functionality of the system 100, computer-implemented method 300, and vice versa.

As illustrated, the CU 104 includes a measurement server 402 and an RRC connection accept/reject module 404. Further, the DU 106 includes scheduling functionality (e.g., a scheduler module 406).

QoS prediction module 108 can utilize channel conditions and cell load data to predict an average QoS satisfaction on each cell. The admission control module 110 can utilize predicted QoS satisfaction and measured RRC rejection ratio to make admission decision. The measurement server 402 can facilitate sending the requested performance indicators or other network measurements with the controller 102 and can also facilitate measuring the performance indicators from the network. The RRC connection accept/reject module 404 is responsible for handling connection requests based on admission decision sent by the controller 102.

In further detail, the QoS prediction module 108 (also referred to as a QoS prediction module) is responsible for predicting a KPI representing QoS satisfaction at a Cell level. The QoS satisfaction is a metric that indicates a ratio of UEs within a cell satisfying the QoS criteria based on a preset SLA (Service Level Agreement). The QoS prediction module 108 can use a machine learning model, which is trained on a number of UEs, RSRP, SINR and delay data from offline simulations. The output of the QoS prediction module 108 is a QoS satisfaction prediction that will be used in the admission control module 110 (also referred to as an admission control module) for making decisions whether to accept or reject UEs.

To perform the QoS prediction model training, a machine learning model is trained using historical data. The training data can be collected over a long period of time, from different cells, to diversify the channel conditions and resulting QoS distribution in the dataset. The model is then trained to predict the average cell QoS Satisfaction given the cell's channel conditions (RSRP, SINR) and the number of UEs connected to the cell. Later, updated data can be used to re-train the model, if the performance is deteriorating and/or based on other conditions.

Conventionally, the QoS prediction output was a Packet Data Convergence Protocol (PDCP) delay prediction. The average delay per cell was used as a target variable. However, the PDCP delay prediction presents a shortcoming when the cell contains UEs at the cell edge with relatively high delays while majority of the UEs have satisfactory delay. This leads to the average predicted delay being unsatisfactory, misrepresenting the KPIs for the cell.

To address the above noted technical problem (as well as other issues) associated with conventional processes, the QoS prediction module 108 calculates a difference metric between the measured QoS for a given UE and a preset SLA. The formula for this target variable on the cell level is defined below in Equation 1:

$$\begin{matrix}θ = \frac{{\sum }_{UE = 0}^{UE = U - 1} 1 - \frac{{UE\_delay}_{measured}}{{delay}_{SLA}}}{U} \\ {QoS}_{Satisfaction} = \{ \begin{matrix}θ , & if θ \geq 0 \\ 0 & otherwise\end{matrix}\end{matrix} . \qquad Equation 1$$

where U is the number of UEs on a given cell, UEdelay_{measured} is the PDCP delay measured for a given UE, and delay_{SLA} is the maximum tolerable delay configuration.

The above formula changes the target variable from an absolute delay measurement into an average ratio-based metric, varying according to the percentage of satisfied UEs within a cell. This can help mitigate the effect of outliers in the cell as any degradation beyond the maximum delay is given a value of zero (zero QoS_Satisfaction). Therefore, when a minority of the UEs are experiencing high delay, the effect is not as large. It also enables the Admission Control process to adopt a stochastic approach by defining a ratio with range 0 to 1 leading to the calculation of a probability measure for accepting/rejecting incoming requests.

The output of the QoS prediction module 108 is the ML model prediction of the target variable described above. Upon or after the prediction, the QoS prediction module 108 can trigger the admission control module 110 for decision making.

As illustrated, the controller 102 also includes at least one memory 408, at least one processor 410, at least one data store 412, and a transmitter/receiver component 414. Although not illustrated, the CU 104 and/or the DU 106 can also include similar respective components (e.g., one or more memories, one or more processors, one or more data stores).

The at least one memory 408 can be operatively connected to the at least one processor 410. The at least one memory 408 can store executable instructions, computer executable modules, and/or computer executable components (e.g., the QoS prediction module 108, the admission control module 110, the transmitter/receiver component 414, and so on) that, when executed by the at least one processor 410 can facilitate performance of operations (e.g., the operations discussed with respect to the various methods and/or systems discussed herein). Further, the at least one processor 410 can be utilized to execute computer executable modules and/or computer executable components (e.g., the QoS prediction module 108, the admission control module 110, the transmitter/receiver component 414, and so on) stored in the at least one memory 408.

For example, the at least one memory 408 can store protocols associated with facilitating the admission control and/or traffic steering as discussed herein. Further, the at least one memory 408 can facilitate action to control communication between the system 400 and other systems, one or more network equipment, one or more file storage systems, one or more devices, one or more UEs, such that the system 400 employs stored protocols and/or algorithms to achieve improved overall performance and quality of service of communications networks as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

The at least one processor 410 can facilitate respective analysis of information related to admission control based on adaptive thresholds, determining a QoS satisfaction target variable, which improves the visibility on cell state. For example, an admission control criterion can specify a quality of service satisfaction target, which can be a variable on a scale from 0 to 1.

Further, the at least one processor 410 can facilitate usage of aggregate rejections as a contributing factor when considering an admission decision in order to achieve a balance between the total number of admissions and QoS satisfaction. Further, the at least one processor 410 can facilitate use of a configurable priority between connection rejections and QoS satisfaction to control network behavior. The at least one processor 410 can be a processor dedicated to analyzing and/or generating information received, a processor that controls one or more modules and/or components of the system 400, and/or a processor that both analyzes and generates information received and controls one or more modules and/or components of the system 400.

The transmitter/receiver component 414 can receive one or more requests to access a network from one or more UEs, information indicative of network measurements from network equipment and/or can return information indicative of access request acceptance and/or access request denial. The transmitter/receiver component 414 can be configured to transmit to, and/or receive data from, for example, log files, map trees, a defined entity, one or more other network equipment, and/or other communication devices. Through the transmitter/receiver component 414, the system 400 can concurrently transmit and receive data, can transmit and receive data at different times, or combinations thereof.

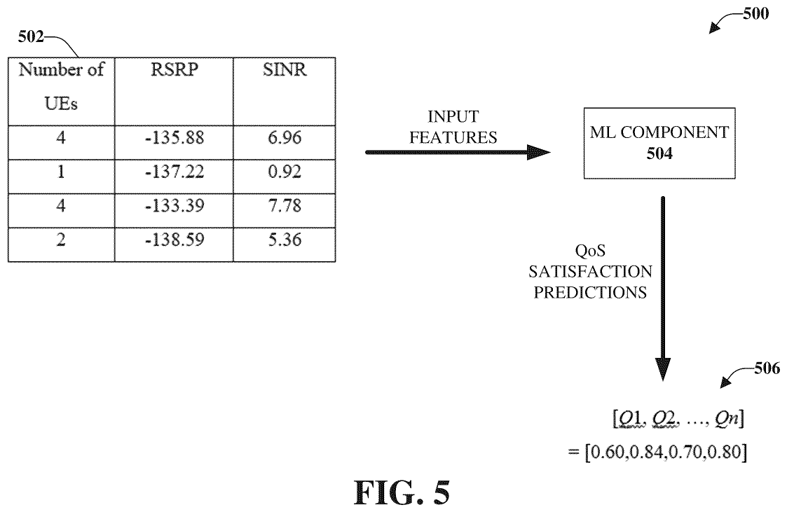

FIG. 5 illustrates an example, non-limiting, QoS satisfaction model 500 in accordance with one or more embodiments described herein. As illustrated in table 502, the number of UEs and respective RSRP and SINR values are utilized as input features to a ML module 504. An output of the ML module 504 includes information indicative of QoS satisfaction predictions, such example, non-limiting QoS satisfaction prediction illustrated at 506.

With continuing reference to FIG. 4, the admission control module 110 is responsible for determining whether to accept or reject a RRC Connection Requests for the cell. The admission control module 110 is triggered periodically (or based on another time interval) by the QoS Prediction module 108. The admission control module 110 receives, as input data, the QoS Satisfaction prediction, discussed above.

The output of the admission control module 110 is an admission decision for every registered cell (e.g., whether to admit or reject incoming UEs). The decisions are stored in the system memory, and are utilized when a subsequent connection request is received by a registered cell. Then the controller 102 retrieves the stored decision for the given cell.

The admission control module 110 can employ a stochastic approach that balances between protecting QoS satisfaction for existing UEs, and maintaining the RRC rejection ratio within a certain target range specified by the system designer.

Since the optimization of the two terms may present a conflicting goal, a tradeoff between QoS satisfaction and avoiding absolute denial of service on highly loaded cells will have to be reached. This approach will improve the behavior of the algorithm in realistic environments, as the applying processes used conventionally would start rejecting all incoming requests after a threshold point beyond which the currently connected UEs are predicted to experience degradations.

Additionally, the system 400 employs a weighted priority configuration between QoS Satisfaction and RRC Rejection Ratio. This will influence the system behavior to prioritize each KPI's optimization accordingly. Such feature is important for operators as the priorities may differ depending on the network deployment scenarios.

It is noted that, for the avoidance of doubt, any embodiments described herein in the context of optimizing actions, network parameters, performance indicators, and so on are not so limited and should be considered also to cover any techniques that implement underlying aspects or parts of the described aspects to improve or increase actions, network parameters, performance indicators, and so on, even if resulting in a sub-optimal variant obtained by relaxing aspects or parts of a given implementation or embodiment.

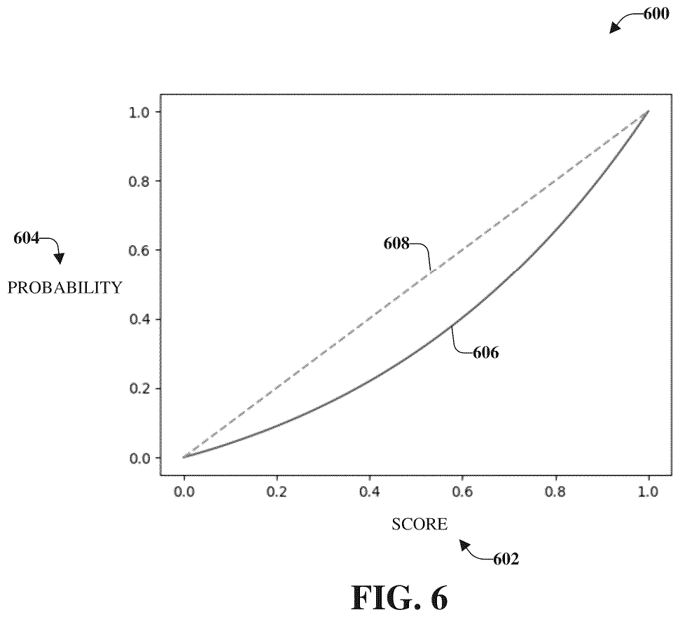

FIG. 6 illustrates an example, non-limiting, graph 600 of a comparison between a probability of admission at a certain time as compared to a score for each cell according to one or more embodiments described herein. Repetitive description of like elements employed in other embodiments described herein is omitted for sake of brevity.

The horizonal axis 602 of the graph 600 represents scores and the vertical axis 604 of the graph 600 represents probabilities. Further, line 606 represents an exponential probability function and line 608 represents the identity function (cell score), as examples.

The admission control module 110 can generate a Net Feasibility Score (NFS). The NFS is an output score for each cell based on the weighted sum according to equation 2 below:

$$Net Feasibility Score ( NFS ) = w * {γ}_{RRC} + ( 1 - w ) * {QoS}_{Satisfied} . \qquad Equation 2$$

where γ_{RRC} is the RRC rejection ratio, which is expressed as

$$\frac{rejected admission requests}{Total number of admission requests} .$$

QoS_{satisfied} is the output from the QoS prediction module and w is defined to different weights for the terms above.

The NFS is then mapped to be a probabilistic measure

$${P}_{adm}^{t} ,$$

which denotes the probability of admission at the instance t at which the admission control is triggered. Using an exponential function as depicted in FIG. 6 gives a lower probability for accepting admission requests for low scores. The RRC Rejection ratio is calculated over a certain time window, after which the value is reset and recalculated. The output probability represents the likelihood of accepting the admission request.

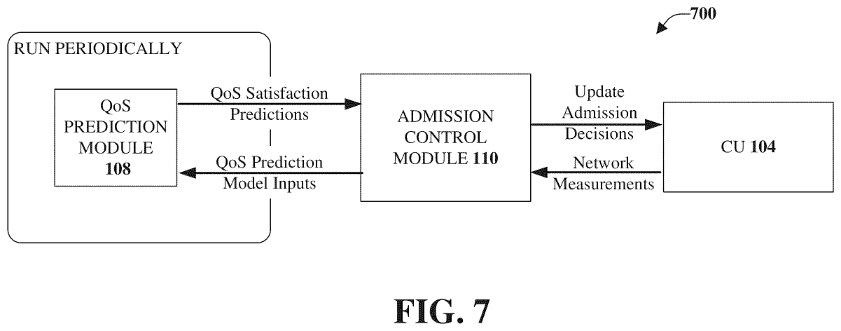

FIG. 7 illustrates an example, non-limiting, flow diagram 700 of the inputs to and the outputs from the admission control module 110 according to one or more embodiments described herein. Repetitive description of like elements employed in other embodiments described herein is omitted for sake of brevity.

The admission control module 110 obtains network measurements from the CU 104. The admission control module 110 pre-processes the counters into KPIs to be fed in the QoS prediction module 108 and forwards the same. The RRC rejection ratio is retained to be used in the admission control decision making process.

Using the QoS satisfaction prediction and the current RRC rejection ratio, the admission control module 110 updates the decision for when an RRC request is received and forwards this to the CU 104.

The decision function described above is computed for each registered cell. Subsequently, the module will update the decisions for each cell on the CU 104. Therefore, the RRC Connection Requests can be handled immediately (or almost immediately) by the CU 104, removing the wait time associated with event-based admission control.

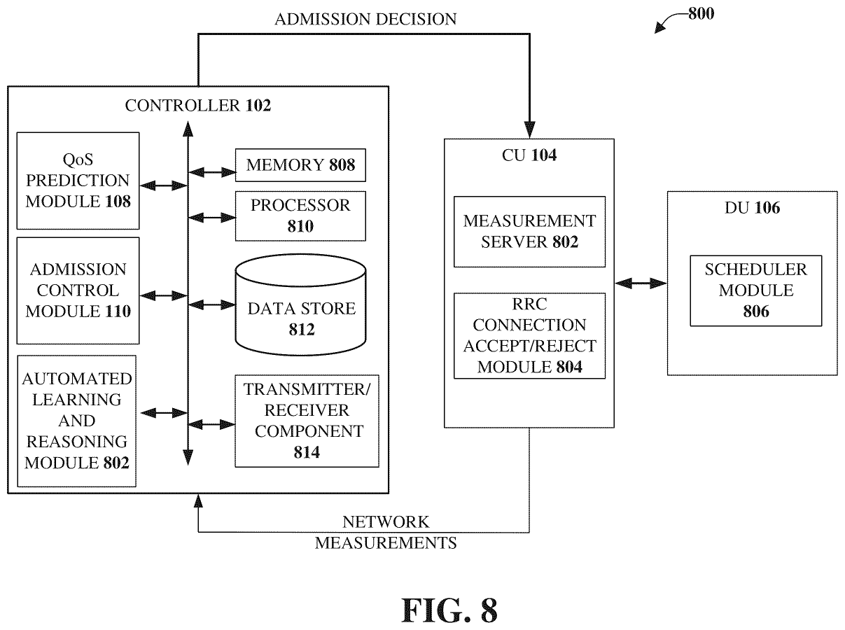

FIG. 8 illustrates a block diagram of an example, non-limiting, system 800 that facilitates training a model for selective and dynamic UE admission control in accordance with one or more embodiments described herein. Repetitive description of like elements employed in other embodiments described herein is omitted for sake of brevity. The system 800 can comprise one or more of the modules, components, and/or functionality of the system 100, the system 400, and vice versa.

The transmitter/receiver component 410 can receive one or more requests from UE for admission into a cellular network (e.g., a communication network). Based on receipt of a request from a user equipment for admission to a cellular network, the QoS prediction module 108 determines an admission threshold for the user equipment. The admission threshold is based on stochastic measurements applicable to the cellular network (e.g., the UEs within the cellular network).

The admission control module 110 analyzes the admission threshold with respect to a defined admission control criterion. Based on the admission threshold being determined to satisfy the defined admission control criterion, the admission control module 110 facilitates granting of the request for admission to the cellular network. Alternatively, based on the admission threshold being determined not to satisfy the defined admission control criterion, the admission control module 110 facilitates denying the request for admission to the cellular network.

The stochastic measurements applicable to the cellular network include network performance indicators that are measured over a defined time interval. For example, the defined admission control criterion specifies a quality of service satisfaction target. The quality of service satisfaction target is variable on a scale from 0 to 1.

According to some implementations, the request is the receipt of a current admission request. Further, to determine the admission threshold for the UE, the QoS prediction module 108 aggregates an amount of admission request denials applied over a defined period, prior to the current admission request. In addition, the QoS prediction module 108 balances the amount of admission request denials applied over the defined period and a quality of service satisfaction level.

In some implementations, determining of the admission threshold by the QoS prediction module 108 can include using a configurable priority between a number of connection rejections and a quality of service satisfaction level. The configurable priority can also be based on respective SLAs of the UEs within the cellular network. The configurable priority can be a weighted priority, for example.

As illustrated, the controller 120 can comprise automated learning and reasoning module 802 that can be utilized to automate one or more of the disclosed aspects. For example, the automated learning and reasoning module 802 can be a model module that trains a model (e.g., the ML module 504). The automated learning and reasoning module 802 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the automated learning and reasoning module 802 can employ principles of probabilistic and decision theoretic inference. Additionally, or alternatively, the automated learning and reasoning module 802 can rely on predictive models constructed using automated learning and/or automated learning procedures. Logic-centric inference can also be employed separately or in conjunction with probabilistic methods.

The automated learning and reasoning module 802 can infer handling of a request (e.g., whether to accept or deny the request, which cell the UE should be admitted to) by obtaining knowledge about the possible actions and knowledge about the network and one or more UEs, which can be based on applications or programs being implemented at the UE, the application/program context, the user context, or combinations thereof. Based on this knowledge, the automated learning and reasoning module 802 can make an inference based on which actions to implement, which UEs to admit, which cell should admit the UE, or combinations thereof.

As used herein, the term “inference” refers generally to the process of reasoning about or inferring states of a system, a component, a module, an environment, and/or devices from a set of observations as captured through events, reports, data and/or through other forms of communication. Inference can be employed to identify a specific context or action, or can generate a probability distribution over states, for example. The inference can be probabilistic. For example, computation of a probability distribution over states of interest based on a consideration of data and/or events. The inference can also refer to techniques employed for composing higher-level events from a set of events and/or data. Such inference can result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

The various aspects (e.g., in connection with traffic steering or UE admission control) can employ various artificial intelligence-based schemes for carrying out various aspects thereof. For example, a process for determining if a particular action should be taken (e.g., rejection, acceptance) can be enabled through an automatic classifier system and process.

A classifier is a function that maps an input attribute vector, x=(x1, x2, x3, x4, xn), to a confidence that the input belongs to a class. In other words, f(x)=confidence (class). Such classification can employ a probabilistic and/or statistical-based analysis (e.g., factoring into the analysis utilities and costs) to provide a prognosis and/or infer one or more actions that should be employed to determine selective admission control to be automatically performed.

A Support Vector Machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing UE behavior, by observing network behavior, by receiving extrinsic information, and so on). For example, SVMs can be configured through a learning or training phase within a classifier constructor and feature selection module. Thus, a classifier(s) can be used to automatically learn and perform a number of functions, including but not limited to determining, according to a predetermined criterion, when to implement an action, which action to implement, what requests to group together, relationships between requests, and so forth. The criteria can include, but is not limited to, similar requests, historical information, and so forth.

Additionally, or alternatively, an implementation scheme (e.g., a rule, a policy, and so on) can be applied to control and/or regulate admission requests and resulting actions. In some implementations, based upon a predefined criterion, the rules-based implementation can automatically and/or dynamically interpret admission requests. In response thereto, the rule-based implementation can automatically interpret and carry out functions associated with the admission request by employing a predefined and/or programmed rule(s) based upon any desired criteria.

According to some implementations, seed data (e.g., a data set) can be utilized as initial input to the model to facilitate the training of the model. In an example, if seed data is utilized, the seed data can be obtained from historical data including historical network measurements, information indicative of previous acceptances and/or denials of UEs into the network, and so on. However, the disclosed implementations are not limited to this implementation and seed data is not necessary to facilitate training of the model. Instead, the model can be trained on new data received (e.g., input data).

The data (e.g., seed data and/or new data) can be collected and, optionally, labeled with various metadata. For example, the data can be labeled with information indicative of various network measurements, information indicative of an identification of the UE (e.g., type of UE, applications executing on the UE, and so on), or other data, such as identification of an entity associated with the UE, a time the admission request was received, updated network measurements after the UE was admitted or denied admission, and so on.

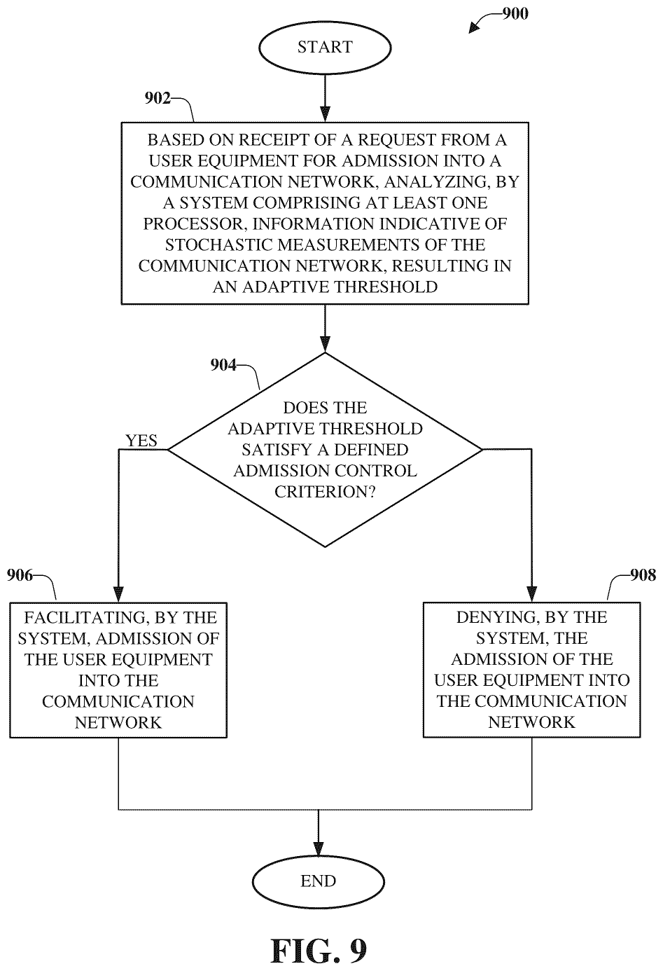

FIG. 9 illustrates a flow diagram of an example, non-limiting, computer-implemented method 900 that facilitates selective and dynamic admission control in advanced communication networks in accordance with one or more embodiments described herein. Repetitive description of like elements employed in other embodiments described herein is omitted for sake of brevity. The computer-implemented method 900 and/or other methods discussed herein can be implemented by a system comprising a processor and a memory. In an example, the system can be implemented by a network equipment of a disaggregated network architecture. For example, the computer-implemented method 900 can be implemented by the system 100, the system 400, and/or the system 800.

The computer-implemented method 900 begins, at 902, with analyzing, by a system comprising at least one processor, information indicative of stochastic measurements of the communication network, resulting in an adaptive threshold. The analyzing can be based on receipt of a request from a UE for admission into a communication network. In some implementations, the information indicative of stochastic measurements of the communication network comprises performance indicators measured over a defined time interval. The performance can include comprise a delay measurement, a reference signal received power measurement, a signal to interference noise ratio measurement, and/or other types of performance measurements. The communication network can be configured to operate according to a fifth generation network communication protocol or another type of advanced network communication protocol.

At 904, a determination is made whether the adaptive threshold satisfies a defined admission control criterion. The defined admission control criterion can be a function of a quality of service satisfaction target variable. Based on the adaptive threshold being determined to satisfy the defined admission control criterion (“YES”), at 906, the computer-implemented method 900 includes facilitating, by the system, admission of the user equipment into the communication network. Alternatively, based on the adaptive threshold being determined to fail to satisfy the defined admission control criterion (“NO”), the admission of the user equipment into the communication network is denied, at 908.

In some implementations, prior to the analysis at 902, the computer-implemented method 900 can include training, by the system, a model to a first defined confidence level. For example, the model can be a deep learning model. However, other types of data-driving and/or machine learning models can be utilized with the disclosed embodiments.

According to some implementations, the analyzing, at 902, can include using information indicative of aggregate rejections of historical admission requests from other user equipment, other than the user equipment, as a contributing factor for an admission decision relating to the admission of the user equipment. Further to these implementations, based on the information indicative of aggregate rejections, the computer-implemented method 900 can include facilitating a balancing between a total number of user equipment admitted into the communication network and a quality of service satisfaction level.

In an example, the analysis can include using a configurable priority between a number of connection rejections and a quality of service satisfaction level. According to another example, the analysis can include determining a difference metric between a measured quality of service level for the user equipment and a quality of service level predefined in a service level agreement for the user equipment.

As discussed, provided herein are embodiments related to admission control in cellular networks using stochastic features or elements, which results in adaptive thresholds based admission criteria instead of fixed SLA thresholds that impose hard limits. Constructing a “QoS Satisfaction” target variable instead of depending on average cell measurements, improving the visibility on cell state is also provided. In addition, use of aggregate rejections as a contributing factor for determination of the admission decision is provided and can be utilized to achieve a desired balance between total number of admissions and QoS satisfaction. Further, provided herein is the use of a configurable priority between connection rejections and QoS satisfaction to control the process behavior.

It should be noted that terms such as “immediately,” “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Example, non-limiting Non-Real Time RAN Intelligent Controller (Non-RT RIC) functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU and O-DU nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) may be designed to handle network functions at real time timescales (e.g., a third range of time representing less time than the first time range and the second time range, such as <10 milliseconds).

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, module, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable module(s) and/or machine-executable component(s) embodied within machine(s) (e.g., embodied in one or more computer readable mediums (or media) associated with one or more machines). Such module(s) and/or component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, modules, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

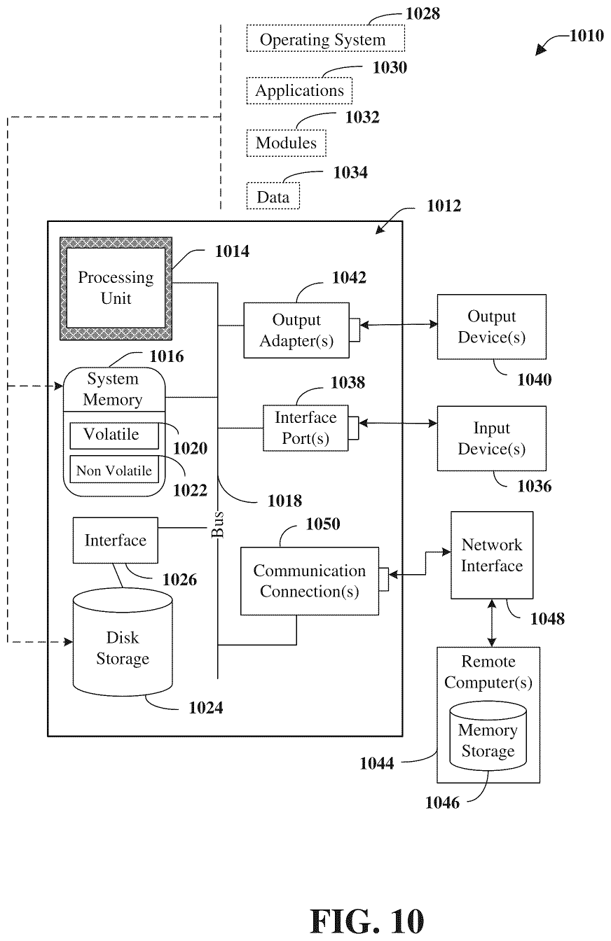

In order to provide a context for the various aspects of the disclosed subject matter, FIG. 10 as well as the following discussion are intended to provide a brief, general description of a suitable environment in which the various aspects of the disclosed subject matter can be implemented.

With reference to FIG. 10, an example environment 1010 for implementing various aspects of the aforementioned subject matter comprises a computer 1012. The computer 1012 comprises a processing unit 1014, a system memory 1016, and a system bus 1018. The system bus 1018 couples system components and/or modules including, but not limited to, the system memory 1016 to the processing unit 1014. The processing unit 1014 can be any of various available processors. Multi-core microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 comprises volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can comprise read only memory (ROM), programmable ROM (PROM), electrically programmable ROM (EPROM), electrically erasable PROM (EEPROM), or flash memory. Volatile memory 1020 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also comprises removable/non-removable, volatile/non-volatile computer storage media. FIG. 10 illustrates, for example a disk storage 1024. Disk storage 1024 comprises, but is not limited to, devices like a magnetic disk drive, floppy disk drive, tape drive, Jaz drive, Zip drive, LS-100 drive, flash memory card, or memory stick. In addition, disk storage 1024 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software comprises an operating system 1028. Operating system 1028, which can be stored on disk storage 1024, acts to control and allocate resources of the computer 1012. System applications 1030 take advantage of the management of resources by operating system 1028 through program modules 1032 and program data 1034 stored either in system memory 1016 or on disk storage 1024. It is to be appreciated that one or more embodiments of the subject disclosure can be implemented with various operating systems or combinations of operating systems.

A user enters commands or information into the computer 1012 through input device(s) 1036. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 comprise, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapters 1042 are provided to illustrate that there are some output devices 1040 like monitors, speakers, and printers, among other output devices 1040, which require special adapters. The output adapters 1042 comprise, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically comprises many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the system bus 1018. While communication connection 1050 is shown for illustrative clarity inside computer 1012, it can also be external to computer 1012. The hardware/software necessary for connection to the network interface 1048 comprises, for exemplary purposes only, internal and external technologies such as, modems including regular telephone grade modems, cable modems and DSL modems, ISDN adapters, and Ethernet cards.

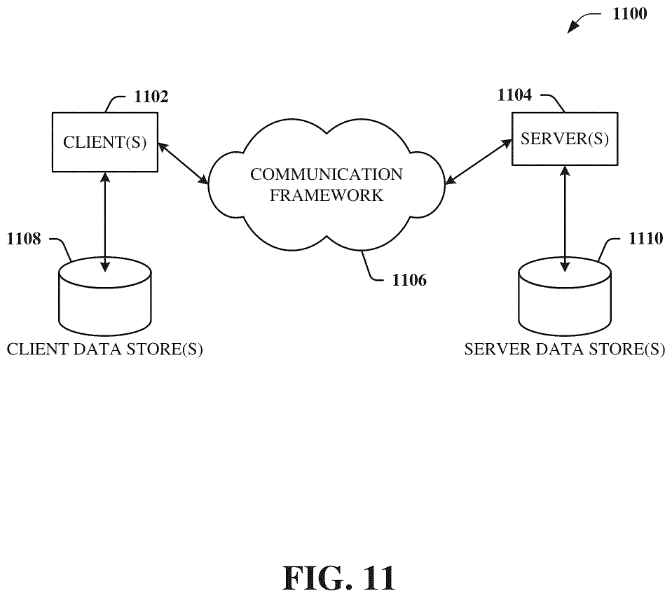

FIG. 11 is a schematic block diagram of a sample computing environment 1100 with which the disclosed subject matter can interact. The sample computing environment 1100 includes one or more client(s) 1102. The client(s) 1102 can be hardware and/or software (e.g., threads, processes, computing devices). The sample computing environment 1100 also includes one or more server(s) 1104. The server(s) 1104 can also be hardware and/or software (e.g., threads, processes, computing devices). The servers 1104 can house threads to perform transformations by employing one or more embodiments as described herein, for example. One possible communication between a client 1102 and servers 1104 can be in the form of a data packet adapted to be transmitted between two or more computer processes. The sample computing environment 1100 includes a communication framework 1106 that can be employed to facilitate communications between the client(s) 1102 and the server(s) 1104. The client(s) 1102 are operably connected to one or more client data store(s) 1108 that can be employed to store information local to the client(s) 1102. Similarly, the server(s) 1104 are operably connected to one or more server data store(s) 1110 that can be employed to store information local to the servers 1104.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “module,” “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more modules and/or components can reside within a process and/or thread of execution and a module and/or component can be localized on one computer and/or distributed between two or more computers. In addition, these modules and/or components can execute from various computer readable media having various data structures stored thereon. The modules and/or components can communicate via local and/or remote processes such as in accordance with a signal having one or more data packets (e.g., data from one component (or module) interacting with another component (or module) in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on receipt of a request from a user equipment for admission into a communication network, analyzing, by a system comprising at least one processor, information indicative of stochastic measurements of the communication network, resulting in an adaptive threshold;
based on the adaptive threshold being determined to satisfy a defined admission control criterion, facilitating, by the system, admission of the user equipment into the communication network, or
based on the adaptive threshold being determined to fail to satisfy the defined admission control criterion, denying, by the system, the admission of the user equipment into the communication network.

2. The method of claim 1, wherein the information indicative of stochastic measurements of the communication network comprises performance indicators measured over a defined time interval.

3. The method of claim 2, wherein the performance indicators comprise a delay measurement, a reference signal received power measurement, or a signal to interference noise ratio measurement.

4. The method of claim 1, wherein the defined admission control criterion is a function of a quality of service satisfaction target variable.

5. The method of claim 1, wherein the analyzing comprises using information indicative of aggregate rejections of historical admission requests from other user equipment, other than the user equipment, as a contributing factor for an admission decision relating to the admission of the user equipment.

6. The method of claim 5, further comprising:
based on the information indicative of aggregate rejections, facilitating a balancing between a total number of user equipment admitted into the communication network and a quality of service satisfaction level.

7. The method of claim 1, wherein the analyzing comprises using a configurable priority between a number of connection rejections and a quality of service satisfaction level.

8. The method of claim 1, further comprising:
prior to the analyzing, training, by the system, a model to a first defined confidence level.

9. The method of claim 8, wherein the model is a deep learning machine learning model.

10. The method of claim 1, wherein the analyzing comprises:
determining a difference metric between a measured quality of service level for the user equipment and a quality of service level predefined in a service level agreement for the user equipment.

11. The method of claim 1, wherein the communication network is configured to operate according to a fifth generation network communication protocol.

12. A system, comprising:
at least one processor; and
at least one memory that stores executable instructions that, when executed by the at least one processor, facilitate performance of operations, comprising:
based on receipt of a request from a user equipment for admission to a cellular network, determining an admission threshold for the user equipment, wherein the admission threshold is based on stochastic measurements applicable to the cellular network;
analyzing the admission threshold with respect to a defined admission control criterion;
based on the admission threshold being determined to satisfy the defined admission control criterion, granting the request for admission to the cellular network; or
based on the admission threshold being determined not to satisfy the defined admission control criterion, denying the request for admission to the cellular network.

13. The system of claim 12, wherein the stochastic measurements applicable to the cellular network comprise network performance indicators that are measured over a defined time interval.

14. The system of claim 13, wherein the defined admission control criterion specifies a quality of service satisfaction target.

15. The system of claim 14, wherein the quality of service satisfaction target is variable on a scale from 0 to 1.

16. The system of claim 12, wherein the receipt of the request is the receipt of a current admission request, and wherein the determining of the admission threshold for the user equipment comprises:
aggregating an amount of admission request denials applied over a defined period, prior to the current admission request; and
balancing the amount of admission request denials applied over the defined period and a quality of service satisfaction level.

17. The system of claim 12, wherein the determining of the admission threshold comprises using a configurable priority between a number of connection rejections and a quality of service satisfaction level.

18. A non-transitory machine-readable medium, comprising executable instructions that, when executed by at least one processor of network equipment, facilitate performance of operations, wherein the operations comprise:
based on an admission request from a user equipment for admission into a wireless communication network, analyzing information indicative of stochastic measurements made with respect to the wireless communication network, resulting in an adaptive threshold;
based on the adaptive threshold being determined to satisfy a defined admission control criterion, enabling admission of the user equipment into the wireless communication network; or
based on the adaptive threshold being determined to fail to satisfy the defined admission control criterion, preventing the admission of the user equipment into the wireless communication network.

19. The non-transitory machine-readable medium of claim 18, wherein the analyzing comprises analyzing a result of using a configurable priority between a number of connection rejections and a quality of service satisfaction level.

20. The non-transitory machine-readable medium of claim 18, wherein the information indicative of stochastic measurements of the wireless communication network comprises performance indicators measured over a defined time interval, and wherein the performance indicators comprise at least one of a delay measurement, a reference signal received power measurement, or a signal to interference noise ratio measurement.
